(19) United States
(12) Patent Application Publication
(10) Pub. No.: US 2022/0222015 A1
(43) Pub. Date: Jul. 14, 2022

(54) STORAGE SYSTEM, STORAGE CONTROL DEVICE, AND STORAGE CONTROL METHOD

(71) Applicant: FUJITSU LIMITED, Kawasaki-shi (JP)

(72) Inventors: Motohiro Sakai, Nerima (JP); Keima ABE, Kawasaki (JP); Takuro Kumabe, Kawasaki (JP); Hidejirou DAIKOKUYA, Kawasaki (JP); JIYU KUSHIHARA, Kawasaki (JP)

(73) Assignee: FUJITSU LIMITED, Kawasaki-shi (JP)

(21) Appl. No.: 17/478,993

(22) Filed: Sep. 20, 2021

(30) Foreign Application Priority Data
Jan. 14, 2021 (JP) 2021-004255

(51) Int. Cl. G06F 3/06

(52) U.S. Cl. CPC G06F 3/0659; G06F 3/0665; G06F 3/0673; G06F 3/0613; G06F 3/0652

(57) ABSTRACT

A storage system includes: a first storage control device; and a second storage control device, wherein, when receiving a switching instruction to switch a device in charge that controls the I/O processing for the logical storage area from the first storage control device to the second storage control device, the first storage control device performs first switching processing of notifying the second storage control device of a management device number that indicates the first storage control device as a device that manages the cache, and executing response processing to switch the device in charge, and when receiving a determination request as to whether data requested to be read from the logical storage area by a readout request hits the cache, the first storage control device determines whether the data hits the cache, and the second storage control device transmits the determination request to the first storage control device.

### CROSS-REFERENCE TO RELATED APPLICATION

This application is based upon and claims the benefit of priority of the prior Japanese Patent Application No. 2021-4255, filed on Jan. 14, 2021, the entire contents of which are incorporated herein by reference.

### FIELD

The embodiments discussed herein are related to a storage system, a storage control device, and a storage control method.

### BACKGROUND

In a storage system including a plurality of storage control devices, for example, a storage control device in charge of input/output (I/O) processing is predetermined for each of a plurality of logical storage areas. Furthermore, in such a storage system, there are some cases where the storage control device in charge of I/O processing for a certain logical storage area is switched, and the I/O processing is taken over by a switching destination storage control device. For example, in a case where a processing load of the switching source storage control device becomes excessive, the storage control device in charge of I/O processing is switched to the storage control device having a lower processing load.

Examples of the related art include as follows: Japanese Laid-open Patent Publication No. 2003-162377; and Japanese. Laid-open Patent Publication No. 2015-169956.

### SUMMARY

According to an aspect of the embodiments, a storage system includes: a first storage control device; and a second storage control device, wherein, in a state of controlling input/output (I/O) processing for a logical storage area using a cache, when receiving a switching instruction configured to switch a device in charge that controls the I/O processing for the logical storage area from the first storage control device to the second storage control device, the first storage control device performs first switching processing of notifying the second storage control device of a management device number that indicates the first storage control device as a device that manages the cache, and executing response processing for the switching instruction to switch the device in charge, and when receiving a determination request as to whether data requested to be read from the logical storage area by a readout request hits the cache from the second storage control device after execution of the first switching processing, the first storage control device determines whether the data hits the cache, and when receiving the readout request after execution of the first switching processing, the second storage control device transmits the determination request to the first storage control device indicated by the notified management device number.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example and a processing example of a storage system according to a first embodiment;

FIG. 2 is a diagram illustrating a configuration example of a storage system according to a second embodiment;

FIG. 3 is a diagram illustrating a hardware configuration example of a CM;

FIG. 4 is a diagram illustrating a configuration example of processing functions of a CM;

FIG. 5 is a diagram for describing a CM in charge and an access path;

FIG. 6 is a diagram for describing I/O processing using a primary cache and a secondary cache;

FIG. 7 is a diagram illustrating a data configuration example of cache management information;

FIG. 8 is an example of a flowchart illustrating readout processing for data from a logical volume;

FIG. 9 is an example of a flowchart illustrating write processing for data to a logical volume;

FIG. 10 is a flowchart illustrating a comparative example of switching processing for a CM in charge;

FIG. 11 is an example of a flowchart illustrating switching processing A for the CM in charge;

FIG. 12 is an example of a sequence diagram illustrating readout processing in a switching destination CM after completion of the switching processing A;

FIG. 13 is an example of a flowchart illustrating switching processing B for the CM in charge;

FIG. 14 is a diagram illustrating a da configuration example of CM in charge management information;

FIG. 15 is an example of a sequence diagram illustrating readout processing in a switching destination CM after completion of the switching processing B;

FIG. 16 is an example (No. 1) of a flowchart illustrating switching control processing when switching of the CM in charge is instructed; and

FIG. 17 is an example (No. 2) of the flowchart illustrating the switching control processing when switching of the CM in charge is instructed.

### DESCRIPTION OF EMBODIMENTS

The following procedure can be considered as a procedure for such switching processing. For example, when switching is instructed, dirty data is written back to a back-end storage device from a cache used in the I/O processing by the switching source storage control device. Then, when the write back of all the dirty data is completed, a response to the switching instruction is performed, and the I/O processing in the switching destination storage control device is started.

Furthermore, the following techniques have been proposed for switching a connection relationship between a cache memory and a storage module. For example, when connection is switched so as to connect a storage module to a cache memory different from a current cache memory, information stored in the pre-switching cache memory is moved to the post-switching cache memory.

By the way, when a response to the switching instruction is performed after write back of the cache dirty data is completed as described above, there is a problem that the time from receiving the switching instruction to the response becomes long. In particular, in the case of using a secondary cache for I/O processing, the capacity of the secondary cache is much larger than that of a primary cache, so there is a high possibility that write back of dirty data in the secondary cache takes a long time, and a response time to the switching instruction becomes long by the time of the write back.

In one aspect, the embodiment is intended to provide a storage system, a storage control device, and a storage control method capable of shortening a response time after receiving a switching instruction of a device in charge of I/O processing.

Hereinafter, the embodiments will be described with reference to the drawings.

### First Embodiment

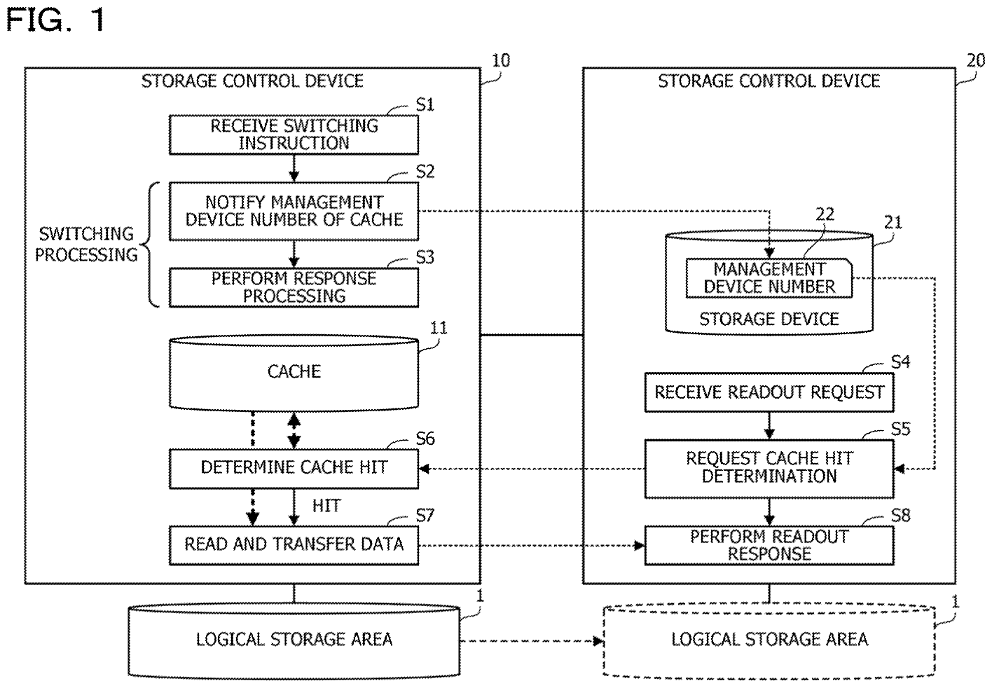

FIG. 1 is a diagram illustrating a configuration example and a processing example of a storage system according to a first embodiment. The storage system illustrated in FIG. 1 includes storage control devices 10 and 20.

The storage control devices 10 and 20 control I/O processing for a logical storage area. As an example in FIG. 1, it is assumed that the storage control device 10 controls the I/O processing for a logical storage area 1. Then, it is assumed that the device in charge of controlling the I/O processing for the logical storage area 1 is switched from the storage control device 10 to the storage control device 20.

The storage control device 10 controls the I/O processing for the logical storage area 1 using a cache 11. The cache 11 is secured in a storage device mounted inside the storage control device 10 or a storage device connected to an outside of the storage control device 10. In such a state, it is assumed that the storage control device 10 receives a switching instruction instructing switching the device in charge from the storage control device 10 to the storage control device 20 (step S1).

Then, the storage control device 10 executes the following switching processing including processing of steps S2 and S3. First, the storage control device 10 notifies the switching destination storage control device 20 of a management device number 22 indicating the storage control device 10 as a device for managing the cache 11 (step S2). The notified management device number 22 is stored in, for example, a storage device 21 included in the storage control device 20. When the storage control device 10 notifies the management device number 22, the storage control device 10 executes response processing to the switching instruction and switches the device in charge to the storage control device 20 (step S3).

As a result, control of the I/O processing for the logical storage area 1 by the switching destination storage control device 20 is started. In this state, it is assumed that the storage control device 20 receives a data readout request from the logical storage area 1 (step S4). Then, the storage control device 20 refers to the notified management device number 22 and recognizes that the management device of the cache 11 corresponding to the logical storage area 1 is the storage control device 10. Then, the storage control device 20 transmits a determination request as to whether the data (readout data) requested to be read by the readout request hits the cache 11 to the storage control device 10 indicated by the management device number 22 (step S5).

When the switching source storage control device 10 receives the determination request, the storage control device 10 determines whether the readout data hits the cache 11 (step S6). Here, for example, when the readout data exists in the cache 11 and a cache hit is determined, the storage control device 10 reads out the readout data from the cache 11 and transfers the readout data to the storage control device 20 (step S7). The storage control device 20 receives the transferred readout data, transmits the received readout data to a transmission source device of the readout request (not illustrated), and executes response processing for the readout request (step S8).

As described above, in the case of receiving the switching instruction of the device in charge, the switching source storage control device 10 responds to the switching instruction to switch the device in charge by simply notifying the switching destination storage control device 20 of the management device number 22 indicating the management device of the cache 11. As a result, the response time after receiving the switching instruction can be shortened as compared with the case of making a response after writing back all the dirty data stored in the cache 11 to a physical storage area that implements the logical storage area 1.

Furthermore, there is a possibility that dirty data remains in the cache 11 at the point of time when the device in charge has been switched. Therefore, it is necessary to enable access to the dirty data remaining in the cache 11 so as to avoid occurrence of data inconsistency when the switching destination storage control device 20 receives the readout request. In the above processing, the management device number 22 is notified to the storage control device 20 at the time of the switching processing. As a result, the switching destination storage control device 20 can request the determination as to whether the readout data hits the cache 11 on the basis of the management device number 22, and can acquire the readout data from the cache 11 in the case where the readout data hits the cache 11.

In this way, the switching source storage control device 10 notifies the management device number 22 instead of executing the write back of the cache 11 so that the storage control device 20 can access the dirty data in the cache 11 after switching, and then completes the switching processing As a result, the response time to the switching instruction can be shortened while avoiding the data inconsistency due to the I/O processing after switching.

### Second Embodiment

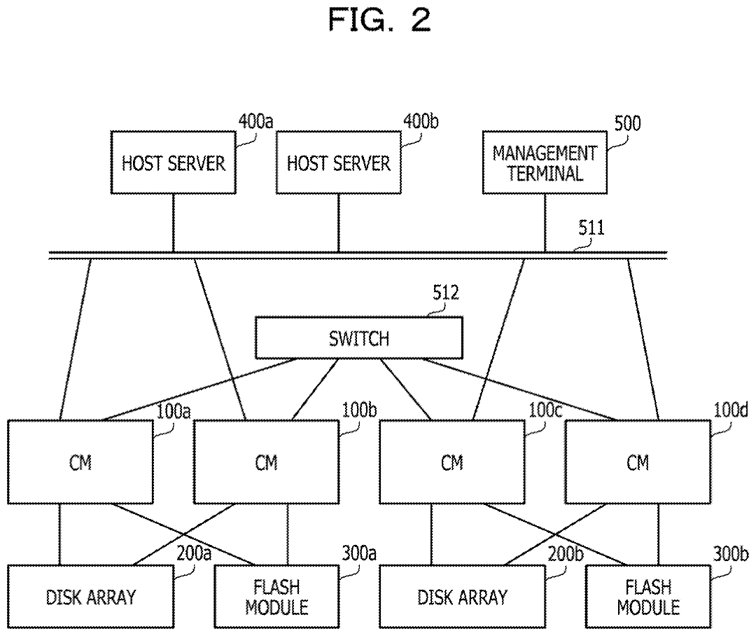

FIG. 2 is a diagram illustrating a configuration example of a storage system according to a second embodiment. The storage system illustrated in FIG. 2 includes controller modules (CMs) 100a to 100d, host servers 400a and 400b, and a management terminal 500.

The CMs 100a to 100d are storage control devices that control I/O processing for logical volumes in response to requests from the host servers 400a and 400b. The logical volume to be controlled for I/O is implemented using a storage device mounted on a disk array.

In the example of FIG. 2, a disk array 200a is connected to the CMs 100a and 100b, and a disk array 200b is connected to the CMs 100c and 100d. In this case, the CMs 100a and 100b basically control the I/O processing for the logical volume implemented using the storage device mounted on the disk array 200a. Furthermore, the CMs 100c and 100d basically control the I/O processing for the logical volume implemented using the storage device mounted on the disk array 200b.

The disk arrays 200a and 200b are each equipped with a plurality of storage devices that implement the storage area of the logical volume. In the present embodiment, as an example, it is assumed that the disk arrays 200a and 200b are equipped with hard disk drives (HDDs) as such storage devices.

Furthermore, the CMs 100a to 100d perform I/O control for the logical volume, using a storage area by a storage device (flash memory) mounted on a flash module as a secondary cache. In the example of FIG. 2, a flash module 300a is connected to the CMs 100a and 100b, and a flash module 300b is connected to the CMs 100c and 100d, The flash modules 300a and 300b are each equipped with a plurality of flash memories.

The CMs 100a to 100d are connected to the host servers 400a and 400b via a network 511. The network 511 is a storage area network (SAN) using, for example, a fibre channel (FC), an Internet small computer system interface (iSCSI), or the like.

Furthermore, the CMs 100a to 100d can communicate with one another via a switch 512. The switch 512 is connected to the CMs 100a to 100d via, for example, a bus of a peripheral component interconnect express (PCI Express, hereinafter abbreviated as “PCIe”) and relays signals transmitted between CMs.

A management terminal 500 is a terminal device operated by an administrator to manage the CMs 100a to 100d and is connected to the CMs 100a to 100d via the network 511.

Note that the number of CMs included in the storage system is not limited to four as illustrated in FIG. 2, and can be set to any number of two or more. Furthermore, the connection relationship between the CMs, and the disk arrays and flash modules is not limited to the example in FIG. 2, and it is only needed that one CM is connected to one or more disk arrays and one or more flash modules.

Furthermore, in the present embodiment, the logical volume is implemented by the storage device (here, HDD) mounted on the disk array. Furthermore, a primary cache and a secondary cache are used during the I/O control for the logical volume. Then, the primary cache is implemented by a random access memory (RAM) in the CM, and the secondary cache is implemented by the storage device (here, the flash memory) in the flash module.

Note that the storage device that implements the secondary cache is only needed to be a nonvolatile storage device that has a higher access speed than the storage device that implements the logical volume and has a slower access speed than the storage device that implements the primary cache. For example, in the case where a solid state drive (SDD) is used as the storage device that implements the logical volume, a so-called storage class memory (SCM) such as magnetoresistive RAM (MRAM), ferroelectric RAM (FeRAM), phase change RAM (PRAM), resistive RAM (ReRAM) or the like may be used as the storage device that implements the secondary cache. Furthermore, the nonvolatile storage device that implements the secondary cache may be built in the CM.

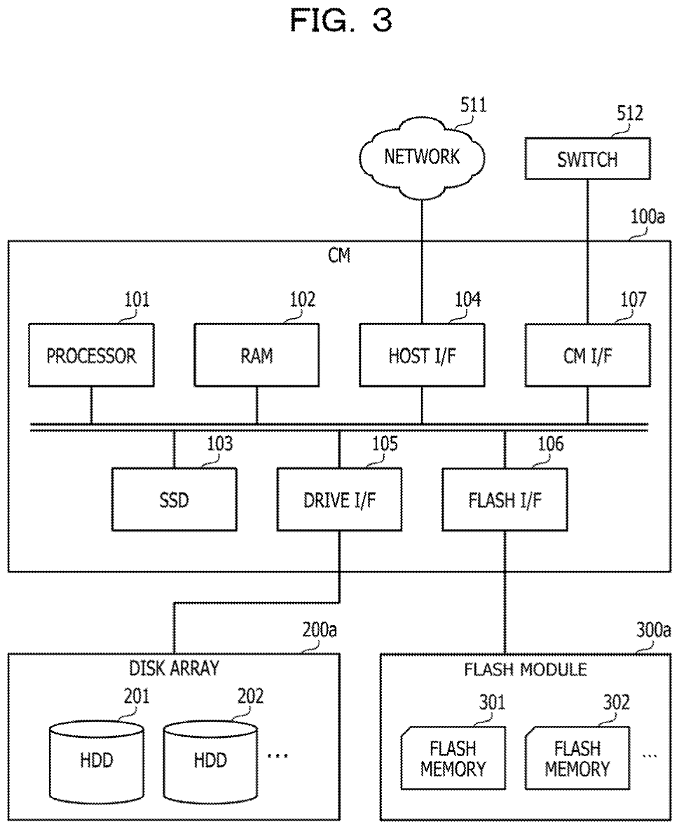

FIG. 3 is a diagram illustrating a hardware configuration example of a CM. FIG. 3 illustrates the CM 100a as an example but other CMs 100b to 100d can be implemented by a similar hardware configuration.

The CM 100a is implemented as, for example, a computer as illustrated in FIG. 3. The CM 100a illustrated in FIG. 3 includes a processor 101, a RAM 102, an SSD 103, a host interface (I/F) 104, a drive interface (I/F) 105, a flash interface (I/F) 106, and a CM interface (I/F) 107.

The processor 101 integrally controls the entire CM 100a. The processor 101 is, for example, a central processing unit (CPU), a micro processing unit (MPU), a digital signal processor (DSP), an application specific integrated circuit (ASIC), or a programmable logic device (PLD). Furthermore, the processor 101 may be a combination of two or more elements of a CPU, an MPU, a DSP, an ASIC, and a PLD.

The RAM 102 is implemented as, for example, a dynamic RAM (DRAM), and is used as a main storage device of the CM 100a. The RAM 102 temporarily stores at least a part of an operating system (OS) program or an application program to be executed by the processor 101. Furthermore, the RAM 102 stores various data needed for processing by the processor 101. Note that, as will be described below, a part of a storage area of the RAM 102 is used as the primary cache during the I/O control for the logical volume.

The SSD 103 is used as an auxiliary storage device of the CM 100a. The SSD 103 stores the OS program, the application program, and various data. Note that another type of nonvolatile storage device such as an HDD can be used as the auxiliary storage device.

The host interface 104 communicates with the host servers 400a and 400b and the management terminal 500 via the network 511.

The drive interface 105 is connected to the disk array 200a. As illustrated in FIG. 3, a plurality of HDDs 201, 202, . . . , and the like is mounted on the disk array 200a. The drive interface 105 communicates with the HDDs 201, 202, . . . , and the like mounted on the disk array 200a.

The flash interface 106 is connected to the flash module 300a. As illustrated in FIG. 3, a plurality of flash memories 301, 302, . . . , and the like is mounted on the flash module 300a. The flash interface 106 communicates with the flash memories 301, 302, . . . , and the like mounted on the flash module 300a.

The CM interface 107 communicates with the other CMs 100b to 100d via the switch 512.

Processing functions of the CM 100a can be implemented by the above-described hardware configuration, Note that, for example, the host servers 400a and 400b can also be implemented as a computer having the hardware configuration as illustrated in. FIG. 3.

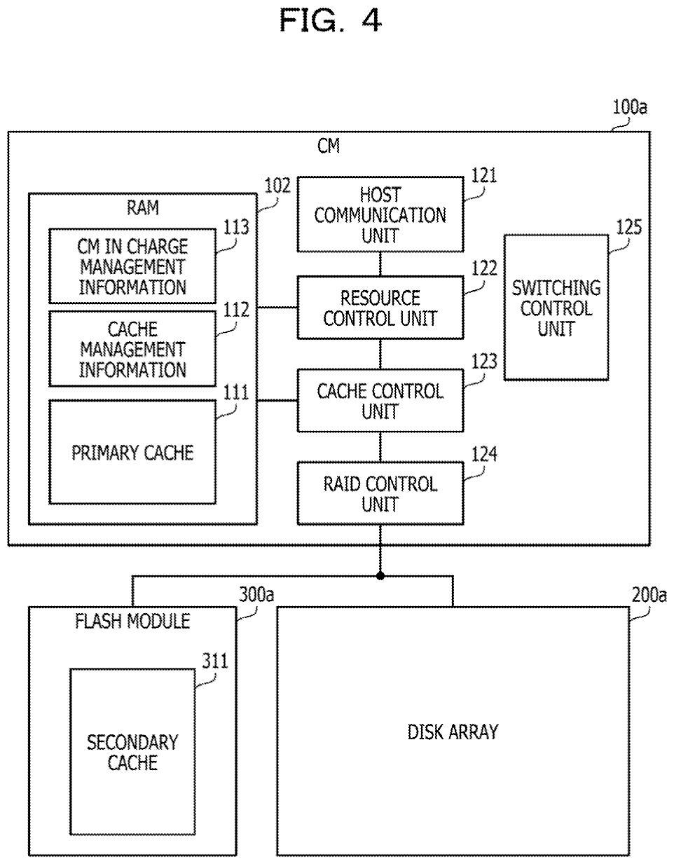

FIG. 4 is a diagram illustrating a configuration example of processing functions of the CM. FIG. 4 illustrates the CM 100a as an example but the other CMs 100b to 100d have similar processing functions.

First, the area of the primary cache 111 is secured in the RAM 102. Furthermore, the area of the secondary cache 311 is secured in the flash module 300a. The CM 100a controls the I/O processing for the logical volume, using the primary cache 111 and the secondary cache 311.

Furthermore, cache management information 112 and CM in charge management information 113 are stored in the RAM 102. The cache management information 112 is information for managing the primary cache 111 and the secondary cache 311, and includes, for example, information indicating a correspondence relationship between an address on the logical volume and an address on the cache, information indicating an attribute of data on the logical volume, and the like. The CM in charge management information 113 is information indicating a correspondence relationship between the logical volume and the CM in charge. The “CM in charge” indicates a CM that controls the I/O processing for the logical volume.

Furthermore, the CM 100a also includes a host communication unit 121, a resource control unit 122, a cache control unit 123, a redundant array of inexpensive disks (RAID) control unit 124, and a switching control unit 125, Processing of the host communication unit 121, the resource control unit 122, the cache control unit 123, the RAID control unit 124, and the switching control unit 125 is implemented by, for example, the processor 101 included in the CM 100a executing a predetermined application program.

The host communication unit 121 executes communication processing with the host servers 400a and 400b and with the management terminal 500. For example, the host communication unit 121 receives an I/O request from the host server 400a or 400b, and transmits a response to the I/O request to the host server 400a or 400b.

The resource control unit 122 determines the CM in charge of the logical volume that is the target of the I/O request received by the host communication unit 121 with reference to the CM in charge management information 113. In the case where the CM in charge is its own CM (here, the CM 100a), the resource control unit 122 passes the I/O request to the cache control unit 123 in its own CM. Meanwhile, in the case where the CM in charge is another CM, the resource control unit 122 transfers the I/O request to that CM. Furthermore, when receiving the I/O request transferred from the resource control unit of another CM, the resource control unit 122 passes the I/O request to the cache control unit 123 in its own CM.

The cache control unit 123 executes the I/O processing in accordance with the I/O request, using the primary cache 111 and the secondary cache 311.

The RAID control unit 124 controls the I/O processing for the disk array 200a and the I/O processing for the flash module 300a, using RAID. For example, when receiving a request to write data in the logical volume to the disk array 200a from the cache control unit 123, the RAID control unit 124 writes the data such that the data is made redundant in the plurality of HDDs in the disk array 200a. Furthermore, when receiving a data write request to the secondary cache 311 from the cache control unit 123, the RAID control unit 124 writes the data such that the data is made redundant in a plurality of flash memories in the flash module 300a.

Note that a RAID level for such I/O control is arbitrarily set for each of the disk array 200a and the flash module 300a. Furthermore, these RAID levels may be individually set for each logical volume.

The switching control unit 125 controls the switching processing of the CM in charge.

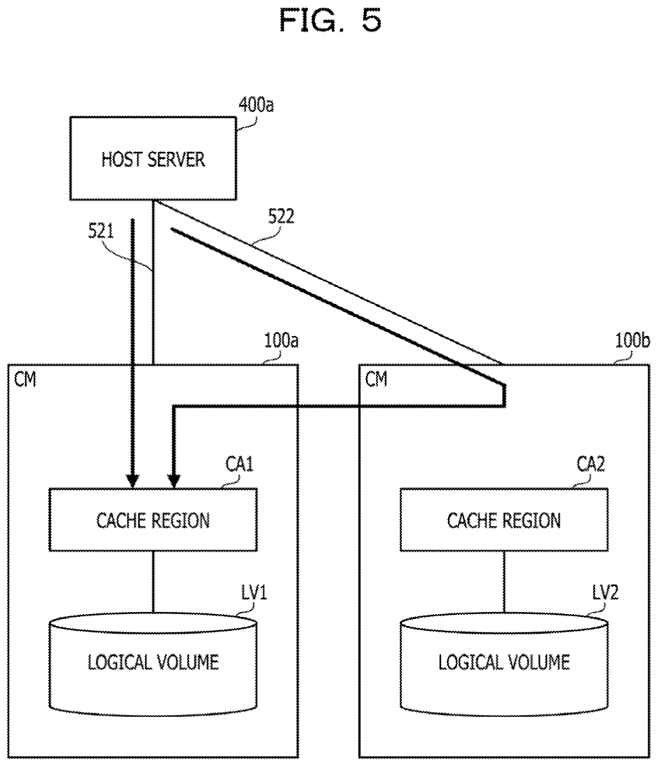

FIG. 5 is a diagram for describing the CM in charge and an access path. As described above, the CM in charge indicates a CM that controls the I/O processing for the logical volume. One CM in charge of the I/O control is associated with each of the logical volumes to be accessed from the host servers 400a and 400b.

In the example of FIG. 5, the CM 100a is set as the CM in charge of a logical volume LV1, and the CM 100b is set as the CM in charge of a logical volume LV2. In this case, the CM 100a controls access processing for the logical volume LV1, using a cache area CA1 secured in association with the logical volume LV1. Furthermore, the CM 100b controls access processing for the logical volume LV2, using a cache area CA2 secured in association with the logical volume LV2.

Note that both the cache areas CA1 and CA2 actually include each area of the primary cache and the secondary cache. Furthermore, both the logical volumes LV1 and LV2 are implemented using a plurality of HDDs included in the disk array 200a or the disk array 200b, and the data is redundantly stored in the plurality of HDDs by RAID.

Meanwhile, the host servers 400a and 400b can use a plurality of access paths when accessing a certain logical volume. As a result, even if one access path is blocked due to an abnormality or the like, the I/O processing with the logical volume can be continued via another access path.

In the example of FIG. 5, as the access paths for the host server 400a to access the logical volume LV1, an access path 521 between the host server 400a and the CM 100a and an access path 522 between the host server 400a and the CM 100b are set. Here, each of the CMs 100a to 100d has the CM in charge management information 113 indicating the correspondence relationship between the logical volume and the CM in charge. Then, when receiving the I/O request for the logical volume from any of the host servers, the resource control unit 122 of the CMs 100a to 100d determines the CM in charge of the logical volume on the basis of the CM in charge management information 113. In the case where the CM in charge is another CM, the resource control unit 122 transfers the I/O request to that CM.

For example, in FIG. 5, it is assumed that the host server 400a uses the access path 521 and transmits the I/O request for the logical volume LV1 to the CM 100a. In this case, the resource control unit 122 of the CM 100a passes the received I/O request to the cache control unit 123 of the CM 100a on the basis of the CM in charge management information 113. Meanwhile, it is assumed that the host server 400a uses the access path 522 and transmits the I/O request for the logical volume LV1 to the CM 100b. In this case, the resource control unit 122 of the CM 100b transfers the received I/O request to the CM 100a that is the CM in charge on the basis of the CM in charge management information 113. The transferred I/O request is passed to the cache control unit 123 of the CM 100a. In this way, the I/O processing for the logical volume LV1 is controlled by the CM 100a that is the CM in charge regardless of which of the access path 521 or 522 is used to transmit the request.

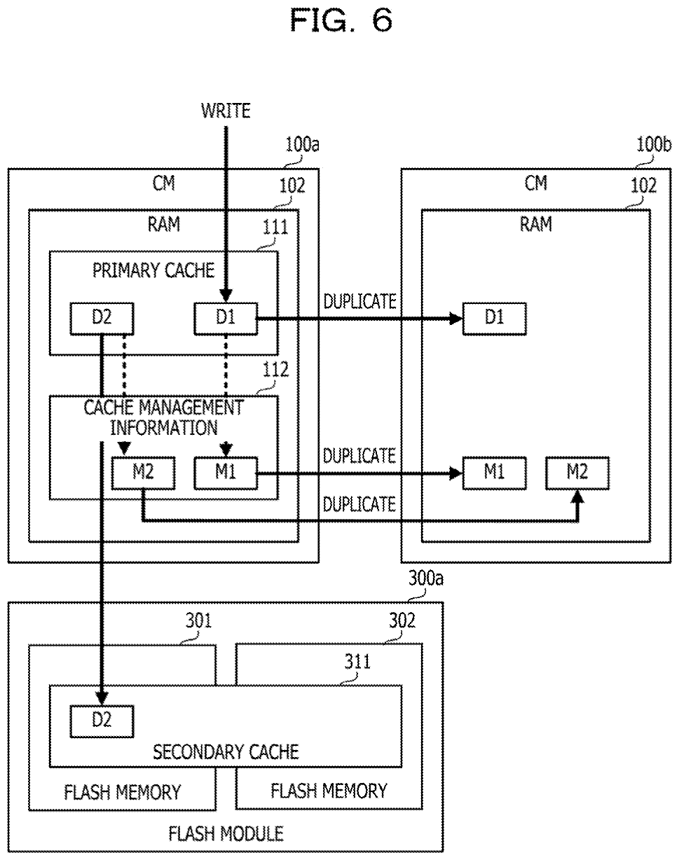

FIG. 6 is a diagram for describing the I/O processing using the primary cache and the secondary cache. As described above, the I/O processing for the logical volume is controlled using the primary cache 111 implemented by the RAM 102 and the secondary cache 311 implemented by the flash module (here, the flash module 300a).

For example, it is assumed that the CM 100a is requested to write data D1 to the logical volume. In this case, the cache control unit 123 of the CM 100a writes the data D1 to the primary cache 111. At the same time, to avoid data loss due to a malfunction of the CM 100a, the cache control unit 123 transfers the data D1 to a predetermined backup destination CM (here, the CM 100b). As a result, the data D1 is also written to the RAM 101 of the CM 100b, and the data D1 is duplicated. When these processes are completed, the cache control unit 123 returns a response to the host server as the write request source.

Furthermore, in the case where a free space of the primary cache 111 is not sufficient when writing data to the primary cache 111, the cache control unit 123 moves data having the earliest final access time among data in the primary cache 111 to the secondary cache 311. In the example of FIG. 6, it is assumed that data D2 is moved from the primary cache 111 to the secondary cache 311. Here, in the write to the secondary cache 311, the data is redundantly written in the plurality of flash memories on the flash module 300a. For example, in the case of controlling data using the flash memories 301 and 302 by RAID1, the data D2 is mirrored to the flash memories 301 and 302.

Note that, cases where data is written to the secondary cache 311 include a case where data hits the secondary cache 311 for the write request from the host server in addition to the case where data is expelled from the primary cache 111 as described above.

By the way, the write of data to the primary cache 111 and the secondary cache 311 is managed using the cache management information 112 stored in the RAM 102. When data is written to the primary cache 111 or the secondary cache 311, management data related to the data is registered in the cache management information 112. This management data includes a logical volume number indicating the data write destination, a logical block address (LBA) on the logical volume, and a storage destination address in the cache area. In the case of writing data to the primary cache 111, a memory address on the RAM 102 is registered as the storage destination address, for example. In the case of writing data to the secondary cache 311, an address in the logical storage area (RAID volume) implemented by controlling a plurality of flash memories on the flash module 300a by RAID is registered as the storage destination address, for example.

Furthermore, when the management data is newly registered in the cache management information 112, the management data is transferred to the backup destination CM 100b and stored in the RAM 102 of the CM 100b. Furthermore, when the management data in the cache management information 112 is updated, the corresponding management data stored in the backup destination CM 100b is also updated. In this way, at least the management data corresponding to the dirty data on the cache is duplicated.

In the example of FIG. 6, when the data D1 is written to the primary cache 111, management data M1 corresponding to the data D1 is registered in the cache management information 112. At the same time, the registered management data M1 is transferred to the CM 100b and stored in the RAM 102 of the CM 100b.

Furthermore, when the data D2 moves from the primary cache 111 to the secondary cache 311, the storage destination address in the cache area, of the management data M2 corresponding to the data D2, is updated. At the same time, the updated management data M2 is transferred to the CM 100b, and the management data M2 stored in the RAM 102 of the CM 100b is updated with the updated management data M2. Thereby, the management data M2 is duplicated.

As in the example of this management data M2, the management data related to the secondary cache 311 is stored in the RAM in the CM, not in the flash module in which the area of the secondary cache 311 is secured. Thereby, the speed of read and write of the management data can be improved, and as a result, the speed of the I/O processing using the primary cache 111 and the secondary cache 311 can be increased.

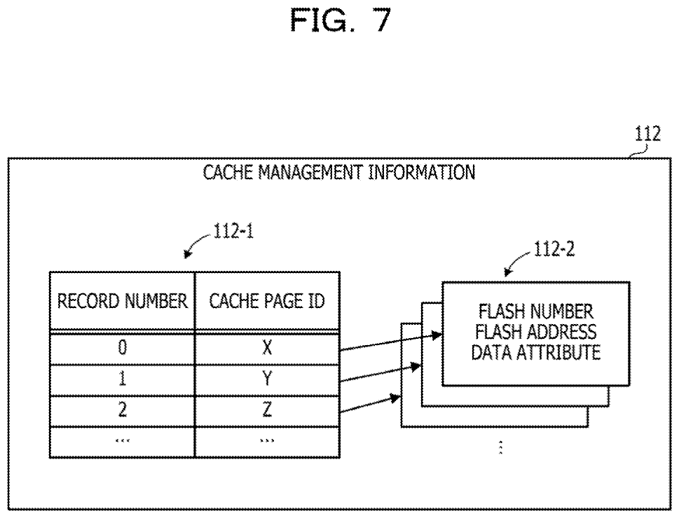

FIG. 7 is a diagram illustrating a data configuration example of the cache management information. The cache management information 112 includes a hash table 112-1 and page management information 112-2. These hash table 112-1 and page management information 112-2 are generated for each of the primary cache 111 and the secondary cache 311. FIG. 7 illustrates, as an example, the hash table 112-1 and the page management information 112-2 for the secondary cache 311.

A record for each cache page (for each cache page of the secondary cache 311 in the example of FIG. 7), which is a unit area in the cache area, is registered in the hash table 112-1. A record number that identifies the record and a cache page ID that identifies the cache page are registered in each record.

Furthermore, in the cache management information 112, page management information 112-2 is registered for each cache page ID (that is, for each cache page). In the page management information 112-2, physical position information of the cache page and data attribute indicating an attribute of data stored in the cache page are registered. In FIG. 7, as an example, the storage area of the secondary cache 311 in the flash module is assumed to be managed by RAID1, and a flash number indicating a main flash memory and a flash address indicating an address in the flash memory are registered as the physical position information. The data attribute indicates whether the stored data is dirty data (whether the data has been written back).

Here, the record number of the hash table 112-1 is a hash key based on data write destination information in the logical volume. For example, when write of data to the logical volume is requested, the cache control unit 123 calculates the hash key on the basis of the volume number of the logical volume and a first logical address of the write destination range in the logical volume. In the case where the same record number as the calculated hash key is not present in the hash table 112-1 (in the case of a cache miss), the cache control unit 123 registers a new record in the hash table 112-1 and registers the hash key as the record number. Furthermore, the cache control unit 123 acquires the cache page ID of a free cache page, registers the cache page ID in the record, and registers the data attribute indicating dirty data to the page management information 112-2 corresponding to the acquired cache page ID.

Note that the management data M2 illustrated in FIG. 6 indicates the record corresponding to the cache page in which the data D2 is stored and the page management information 112-2 corresponding to this record among the records in the hash table 112-1.

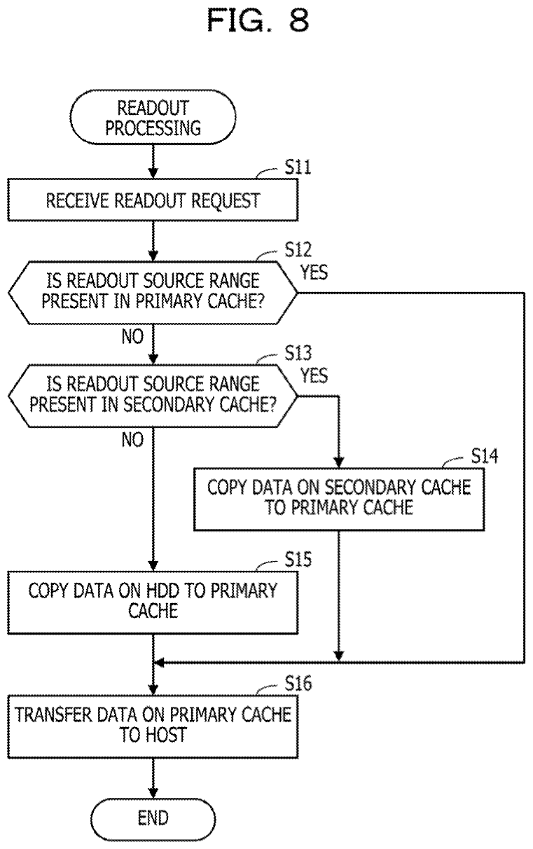

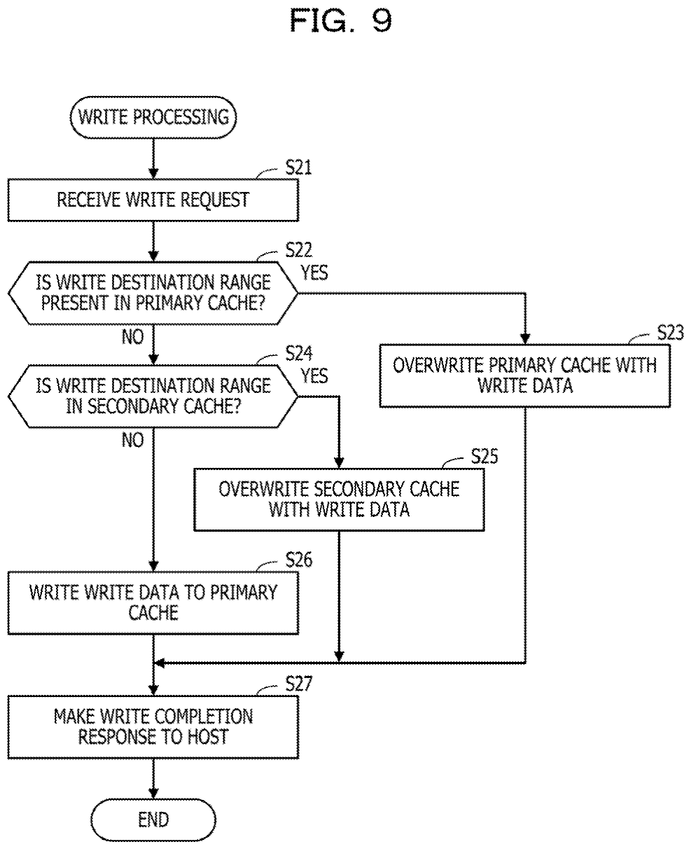

Next, an I/O processing procedure for the logical volume will be described with reference to the flowcharts of FIGS. 8 and 9. In FIGS. 8 and 9, the I/O processing in the CM 100a for the logical volume in which the CM 100a is the CM in charge will be described as an example.

FIG. 8 is an example of a flowchart illustrating readout processing for data from a logical volume.

[step S11] The host communication unit 121 of the CM 100a receives the readout request from the logical volume from the host server and passes the readout request to the resource control unit 122. When determining that the CM in charge of the readout source logical volume is the CM 100a on the basis of the CM in charge management information 113, the resource control unit 122 passes the readout request to the cache control unit 123.

Note that, for example, in the case where another CM receives the readout request, the resource control unit 122 of that CM determines that the CM in charge is the CM 100a on the basis of the CM in charge management information 113, and transfers the readout request to the CM 100a. In the CM 100a, the resource control unit 122 receives the transferred readout request and passes the readout request to the cache control unit 123.

[step S12] The cache control unit 123 refers to the hash table for the primary cache 111 included in the cache management information 112, and determines whether the data in the readout source range in the logical volume is present in the primary cache 111. In the case where the record in which the hash key calculated on the basis of the volume number and the readout source address of the readout source logical volume is registered as the record number is registered in the hash table, the data in the readout source range is determined to be present in the primary cache 111 (primary cache hit). In the case where the data in the readout source range is present in the primary cache 111, the processing proceeds to step S16, or in the case where the data is not present, the processing proceeds to step S13.

[step S13] The cache control unit 123 refers to the hash table for the secondary cache 311 included in the cache management information 112, and determines whether the data in the readout source range in the logical volume is present in the secondary cache 311. In the case where the record in which the hash key calculated on the basis of the volume number and the readout source address of the readout source logical volume is registered as the record number is registered in the hash table, the data in the readout source range is determined to be present in the secondary cache 311 (secondary cache hit). In the case where the data in the readout source range is present in the secondary cache 311, the processing proceeds to step S14, or in the case where the data is not present, the processing proceeds to step S15.

[step S14] The cache control unit 123 reads the data in the readout source range from the secondary cache 311 and copies the data to the primary cache 111. At this time, the cache control unit 123 transfers the read data to the backup destination CM and duplicates the data in the RAM 101. Furthermore, the cache control unit 123 updates the management data corresponding to the copy destination cache page among the management data included in the cache management information 112, and transfers the updated management data to the backup destination CM and duplicates the updated management data in the RAM 101.

[step S15] The cache control unit 123 reads the data in the readout source range from the HDD in the disk array 200a and copies the data to the primary cache 111. At this time, the cache control unit 123 transfers the read data to the backup destination CM and duplicates the data in the RAM 101. Furthermore, the cache control unit 123 updates the management data corresponding to the copy destination cache page among the management data included in the cache management information 112, and transfers the updated management data to the backup destination CM and duplicates the updated management data in the RAM 101.

Note that, in steps S14 and S15, in the case where the free space of the primary cache 111 is insufficient, the data stored in the cache page having the earliest final access time among the cache pages on the primary cache 111 is expelled to the secondary cache 311. Then, the data read from the secondary cache 311 or the HDD is stored in the cache page.

[step S16] The cache control unit 123 reads the data requested to be read from the primary cache 111. Under the control of the resource control unit 122, the read data is transferred to the host server via the host communication unit 121 in the CM that has received the readout request.

FIG. 9 is an example of a flowchart illustrating write processing for data to the logical volume.

[step S21] The host communication unit 121 of the CM 100a receives the write request and write data for the logical volume from the host server and passes them to the resource control unit 122. When determining that the CM in charge of the write destination logical volume is the CM 100a on the basis of the CM in charge management information 113, the resource control unit 122 passes the write request and the write data to the cache control unit 123.

Note that, for example, in the case where another CM receives the write request and write data, the resource control unit 122 of that CM determines that the CM in charge is the CM 100a on the basis of the CM in charge management information 113, and transfers the write request and write data to the CM 100a. In the CM 100a, the resource control unit 122 receives the transferred readout request and write data, and passes the transferred readout request and write data to the cache control unit 123.

[step S22] The cache control unit 123 refers to the hash table for the primary cache 111 included in the cache management information 112, and determines whether the data in the write destination range in the logical volume is present in the primary cache 111. In the case where the record in which the hash key calculated on the basis of the volume number and the write destination address of the write destination logical volume is registered as the record number is registered in the hash table, the data in the write destination range is determined to be present in the primary cache 111 (primary cache hit). In the case where the data in the write destination range is present in the primary cache 111, the processing proceeds to step S23, or in the case where the data is not present, the processing proceeds to step S24.

[step S23] The cache control unit 123 overwrites the data in the write destination range stored in the primary cache 111 with the write data. At this time, the cache control unit 123 transfers the write data to the backup destination CM and overwrites the original data in the write destination range duplicated in the RAM 101.

[step S24] The cache control unit 123 refers to the hash table for the secondary cache 311 included in the cache management information 112, and determines whether the data in the write destination range in the logical volume is present in the secondary cache 311, In the case where the record in which the hash key calculated on the basis of the volume number and the write destination address of the write destination logical volume is registered as the record number is registered in the hash table, the data in the write destination range is determined to be present in the secondary cache 311 (secondary cache hit). In the case where the data in the write destination range is present in the secondary cache 311, the processing proceeds to step S25, or in the case where the data is not present, the processing proceeds to step S26.

[step S25] The cache control unit 123 overwrites the data in the write destination range stored in the secondary cache 311 with the write data.

[step S26] The cache control unit 123 writes the write data to the primary cache 111, transfers the write data to the backup destination CM, and duplicates the write data in the RAM 101. Furthermore, the cache control unit 123 newly registers the management data corresponding to the cache page of the data write destination in the cache management information 112, transfers the management data to the backup destination CM, and duplicates the management data in the RAM 101.

[step S27] The cache control unit 123 requests the resource control unit 122 to perform write completion response processing. By the processing of the resource control unit 122, a write completion response is transmitted to the host server via the host communication unit 121 in the CM that has received the write request.

Note that the data written in the secondary cache 311 according to the procedures illustrated in FIGS. 8 and 9 is written back to the HDD of the disk array at a timing asynchronous with the I/O processing of the logical volume. For example, in the case where a free space is insufficient when writing new data to the secondary cache 311, the data stored in the cache page with the earliest final access time among the cache pages on the secondary cache 311 is expelled, and is written back to the HDD of the disk array. Alternatively, the data on the secondary cache 311 may be written back by background processing. In this case, the cache pages are selected from the cache pages on the secondary cache 311 in the order of the earliest final access time, and the data in the selected cache pages is written back (copied) to the HDD of the disk array. At this time, the data attribute of the page management information corresponding to the selected cache page is updated to indicate that write back has been completed.

Next, the switching processing for the CM in charge for the logical volume will be described.

In the storage system according to the present embodiment, the CM in charge of the logical volume can be switched to any other CM. For example, in the case where a processing load becomes excessive in the CM that is the CM in charge of a certain logical volume, the CM in charge can be switched to the CM having the lowest processing load among the other CMs. Furthermore, as described above, the cache area in each CM and the backup destination CM of the management data are determined in advance, but the switching destination of the CM in charge can be selected regardless of whether the selected CM is the backup destination CM or not.

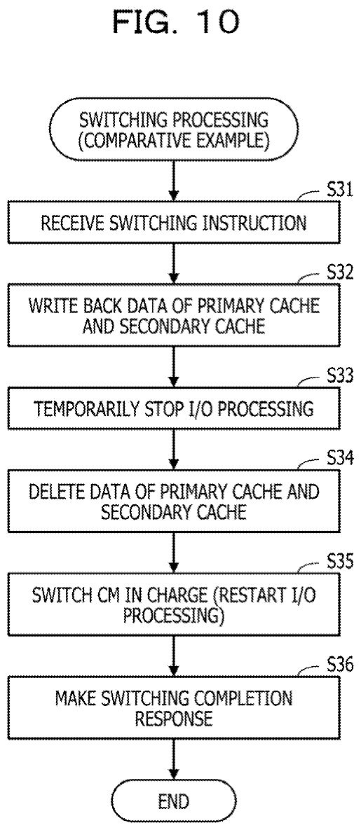

Here, a comparative example of the switching processing for the CM in charge is illustrated in FIG. 10, and then details of the switching processing in the present embodiment will be described.

FIG. 10 is a flowchart illustrating a comparative example of the switching processing for the CM in charge. In the comparative example illustrated in FIG. 10, the CM in charge is switched after writing back all the data in the cache area in order to maintain the consistency of data between the cache area and the back-end storage area.

[step S31] The management terminal 500 transmits the switching instruction for the CM in charge of a certain logical volume to the CM 100a. Here, as an example, it is assumed that the CM in charge of the logical volume LV1 is instructed to be switched from the CM 100a to the CM 100c. The host communication unit 121 of the CM 100a receives the switching instruction and passes the switching instruction to the switching control unit 125.

[step S32] The switching control unit 125 instructs the cache control unit 123 to write back the dirty data of the primary cache 111 and the secondary cache 311. In response to this instruction, the cache control unit 123 writes back the dirty data of the primary cache 111 and the secondary cache 311 to the corresponding HDD of the disk array 200a.

[step S33] When the write back of all dirty data is completed in step S33, the switching control unit 125 causes the cache control unit 123 to stop the I/O processing for the logical volume LV1.

[step S34] The switching control unit 125 instructs deletion of all the data stored in the primary cache 111 and the secondary cache 311. In response to this instruction, the cache control unit 123 deletes all the data stored in the primary cache 111 and the secondary cache 311.

[step S35] When all the corresponding data is deleted in step S34, the switching control unit 125 executes processing of switching the CM in charge of the logical volume LV1 to the CM 100c. Specifically, the switching control unit 125 updates the CM in charge management information 113 such that the CM in charge of the logical volume LV1 indicates the CM 100c. Furthermore, the switching control unit 125 notifies the other CMs that the CM in charge of the logical volume LV1 is switched to the CM 100c to update the CM in charge management information 113 of each CM.

When this step S35 is executed, the switching destination CM 100c restarts the I/O processing for the logical volume LV1. At this time, the cache control unit 123 of the CM 100c can control the I/O processing for the logical volume LV1, using the primary cache secured in the RAM 102 provided in the CM 100c and the secondary cache secured in the flash module connected to the CM 100c.

[step S36] The switching control unit 125 transmits the switching completion response of the CM in charge to the management terminal 500 via the host communication unit 121.

Note that, in the case where data write to the logical volume LV1 is requested during the period from the start of step S31 to the completion of step S35, the cache control unit 123 of the switching source CM 100a directly writes the write data to the back-end storage area without writing the write data to the cache area, for example. Meanwhile, in the case where the cache hit is determined when the data readout from the logical volume LV1 is requested during this period, the cache control unit 123 can read the data from the cache area. However, to avoid data inconsistency, it is desirable that data is not moved or copied between the primary cache 111 and the secondary cache 311.

The switching processing for the CM in charge as illustrated in FIG. 10 above has a problem that the response time from receiving the switching instruction to making a switching completion response is long. This response time mainly depends on the time spent on writing back the data in the primary cache 111 and the secondary cache 311. In particular, the capacity of the secondary cache 311 is much larger than the capacity of the primary cache 111, and the time spent on writing back the data of the secondary cache 311 becoming longer by that capacity increases the time spent on making the switching completion response.

Therefore, in the storage system according to the present embodiment, the following two methods, “switching processing A” and “switching processing B”, are used.

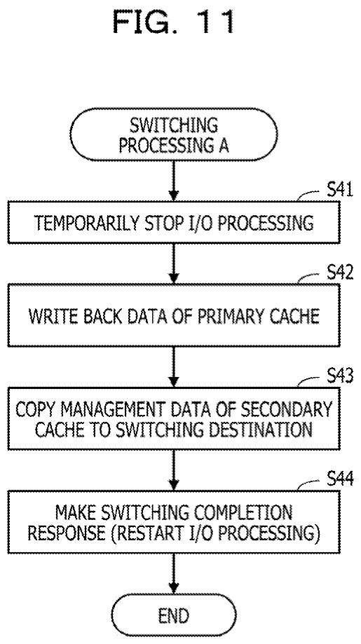

FIG. 11 is an example of a flowchart illustrating the switching processing A for the CM in charge. The processing of FIG. 11 is executed when the switching instruction for the CM in charge is received from the management terminal 500. Here, as in FIG. 10, it is assumed that the CM in charge of the logical volume LV1 is instructed to be switched from the CM 100a to the CM 100c.

[step S41] The switching control unit 125 of the CM 100a causes the cache control unit 123 to stop the I/O processing for the logical volume LV1.

[step S42] The switching control unit 125 instructs the cache control unit 123 to write back the dirty data of the primary cache 111. In response to this instruction, the cache control unit 123 writes back the dirty data of the primary cache 111 to the corresponding HDD of the disk array 200a.

[step S43] The switching control unit 125 transfers the management data related to the secondary cache 311 of the management data included in the cache management information 112 to the switching destination CM 100c and copies the management data in the RAM 102 of the CM 100c. Specifically, the management data (hash table record and page management information) for the cache page in which the dirty data is stored among the cache pages of the secondary cache 311, is copied to the CM 100c. This management data is incorporated into the cache management information 112 to be referred to by the switching destination CM 100c in order to execute the I/O processing for the logical volume LV1.

Note that the processing of steps S42 and S43 may be executed in parallel. Then, when both pieces of the processing of steps S42 and S43 are completed, the processing of step S44 is executed.

[step S44] The switching control unit 125 transmits the switching completion response of the CM in charge to the management terminal 500 via the host communication unit 121. Then, the switching control unit 125 requests the switching destination CM 100c to start the I/O processing. As a result, the CM 100c restarts the I/O processing for the logical volume LV1.

Note that, for example, the management terminal 500 notifies the host server that the CM in charge of the logical volume LV1 has been switched. As a result, the host server can recognize the switched CM in charge for the logical volume LV1 and becomes able to directly transmit the I/O request to the CM in charge.

According to the above switching processing A, the switching processing is completed when the management data of the secondary cache 311 is copied to the switching destination CM 100c instead of not executing the write back of the secondary cache 311. Therefore, the time spent from the switching instruction to the switching completion response can be shortened.

Meanwhile, the switching destination CM 100c starts the I/O processing for the logical volume LV1 when the processing of FIG. 11 is completed. However, at this stage, the dirty data remains in the secondary cache 311 of the switching source CM 100a. Therefore, in order for the switching destination CM 100c to take over the I/O processing correctly, it is necessary to be able to access the dirty data of the switching source secondary cache 311. The management data transferred to the CM 100c in step S43 is incorporated into the cache management information 112 to be referred to by the CM 100c in order to execute the I/O processing for the logical volume LV1. As a result, the transferred (copied) management data is used to access the dirty data of the switching source secondary cache 311 by the CM 100c that has taken over the I/O processing.

In this way, in the switching processing A, the switching processing is completed only by copying the management data for the switching destination CM to access the switching source secondary cache during the I/O processing from the switching source CM to the switching destination CM. As a result, the time from the switching instruction to the response is shortened.

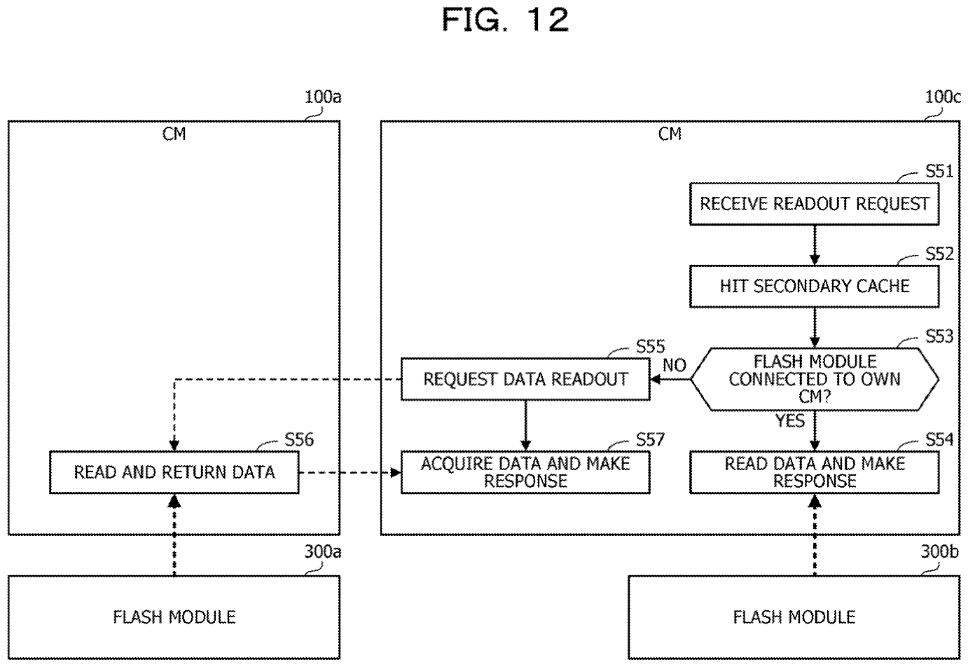

FIG. 12 is an example of a sequence diagram illustrating readout processing in the switching destination CM after completion of the switching processing A.

As described above, when the switching processing A illustrated in FIG. 11 is completed, the switching destination CM 100c starts the I/O processing for the logical volume LV1. At this time, the I/O processing for the logical volume LV1 is controlled using the primary cache secured in the RAM 102 of the CM 100c and the secondary cache secured in the flash module 300b connected to the CM 100c. Since the switching source primary cache has been reset by the switching processing, the primary cache is controlled as usual using the switching destination primary cache. Meanwhile, as for the secondary cache, in the case where readout of the dirty data remaining in the switching source secondary cache, of the logical volume LV1, is requested, the data is read from the switching source secondary cache. As for data in the other areas of the logical volume LV1, the I/O processing is executed using the switching destination secondary cache.

For example, it is assumed that the host server transmits the readout request for the data from the logical volume LV1 and the CM 100c receives the readout request (step S51). Then, it is assumed that the cache control unit 123 of the CM 100c determines that the primary cache has been missed but the secondary cache has been hit on the basis of the cache management information 112 stored by the CM 100c (step S52). That is, it is assumed that the hash key based on the data readout position information matches the record number of any record in the secondary cache hash table in the cache management information 112.

Here, it is assumed that the data requested to be read is determined to be stored in the flash module 300b (stored in the switching destination secondary cache) connected to the CM 100c on the basis of the page management information corresponding to the record (step S53: Yes). In this case, the cache control unit 123 of the CM 100c reads the data requested to be read from the secondary cache after switching secured in the flash module 300b connected to the CM 100c. The read data is transmitted from the host communication unit 121 of the CM 100c to the host server, whereby the response processing is executed (step S54). Actually, the read data is copied to the primary cache of the CM 100c and then transmitted to the host server.

Meanwhile, it is assumed that the data requested to be read is stored in the flash module 300a (stored in the switching source secondary cache) connected to another CM (CM 100a in this case) (step S53: No). This corresponds to the case where the record in which the same record number as the hash key is registered in step S52 is copied from the switching source CM 100a in step S43 in FIG. 11.

In this case, the cache control unit 123 of the CM 100c transmits the flash number and the flash address registered in the page management information corresponding to the record to the switching source CM 100a, and requests readout of data from a location indicated by the transmitted information (step S55). The cache control unit 123 of the CM 100a reads the data from the corresponding location in the flash module 300a, that is, the corresponding location in the switching source secondary cache, and returns the data to the CM 100c (step S56).

The cache control unit 123 of the CM 100c acquires the returned data. This data is transmitted from the host communication unit 121 of the CM 100c to the host server, whereby the response processing is executed (step S57). Actually, the read data is copied to the primary cache of the CM 100c and then transmitted to the host server.

In this way, the switching destination CM 100c can acquire the data that has not been written back and remains in the switching source secondary cache, using the management data of the secondary cache copied by the switching processing A, and transmit the data to the readout request source.

Note that the switching destination CM 100c may control the I/O processing without using the secondary cache using the flash module 300b connected to the CM 100c, for example. In this case, regarding hit determination of the secondary cache, only whether the switching source secondary cache has been hit is determined. By such processing, cache control can be simplified.

Furthermore, the following processing is executed for the write request. For example, in the case where the switching source secondary cache is hit for the write request, the switching destination CM 100c stores the write data to the switching destination primary cache and updates the management data copied from the switching source CM by the switching processing A. At the same time, the CM 100c notifies the switching source CM 100a of the address information on the logical volume LV1 regarding the write data.

As will be described below, the switching source CM 100a writes back the dirty data on the switching source secondary cache in the background after the switching processing A is completed. The switching source CM 100a excludes the corresponding dirty data from the write back target on the basis of the write destination address information notified from the switching destination CM 100a to avoid the write back. Alternatively, the switching source CM 100a immediately writes back the corresponding dirty data on the basis of the notified write data address information. By such processing, occurrence of data inconsistency can be avoided.

Note that, in the examples of FIGS. 11 and 12, the physical area of the logical volume LV1 is implemented by the disk array 200a that cannot be directly accessed from the switching destination CM 100c. In this case, the switching destination CM 100c accesses the physical area of the logical volume LV1 via the CM 100a or the CM 100b in the case of accessing the physical area of the logical volume LV1 when write is requested or when writeback is executed.

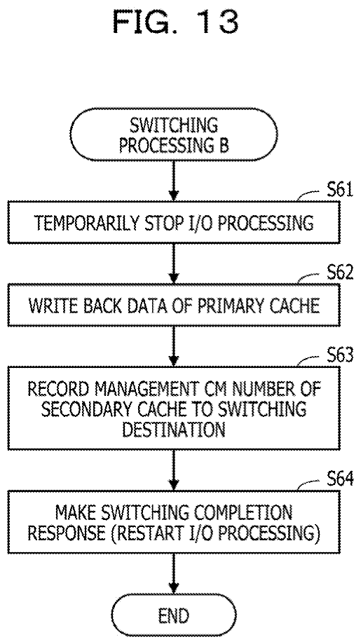

Next, FIG. 13 is an example of a flowchart illustrating the switching processing B for the CM in charge. The processing of FIG. 13 is executed when the switching instruction for the CM in charge is received from the management terminal 500. Here, as in FIGS. 10 and 11, it is assumed that the CM in charge of the logical volume LV1 is instructed to be switched from the CM 100a to the CM 100c.

[step S61] The switching control unit 125 of the CM 100a causes the cache control unit 123 to stop the I/O processing for the logical volume LV1.

[step S62] The switching control unit 125 instructs the cache control unit 123 to write back the dirty data of the primary cache 111. In response to this instruction, the cache control unit 123 writes back the dirty data of the primary cache 111 to the corresponding HDD of the disk array 200a.

[step S63] The switching control unit 125 transmits a CM number indicating the CM 100a as a management CM number of the secondary cache for the logical volume LV1 to the switching destination CM 100c, and causes the CM 100c to record the CM number. In the CM 100c, the transmitted management CM number is recorded in, for example, the RAM 102.

Note that the pieces of processing of steps S62 and S63 may be executed in parallel. Then, when both pieces of the processing of steps S62 and S63 are completed, the processing of step S64 is executed.

[step S64] The switching control unit 125 transmits the switching completion response of the CM in charge to the management terminal 500 via the host communication unit 121. Then, the switching control unit 125 requests the switching destination CM 100c to start the I/O processing. As a result, the CM 100c restarts the I/O processing for the logical volume LV1.

In the above switching processing B, the switching processing is completed by transmitting and recording the management CM number of the secondary cache to the switching destination CM. Therefore, the time from the switching instruction to the response can be shortened as compared with the comparative example illustrated in FIG. 10.

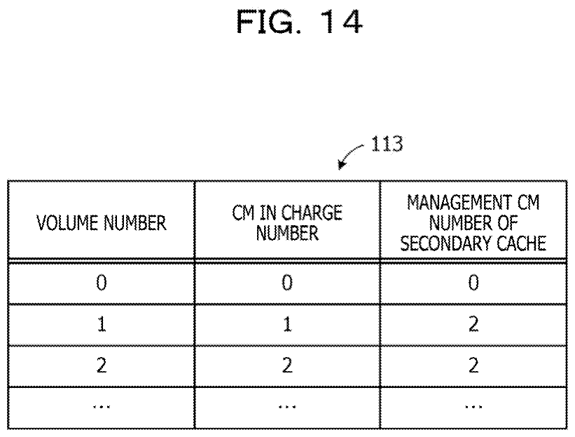

Here, the management CM number transmitted recorded in step S63 will be described with reference to FIG. 14.

FIG. 14 is a diagram illustrating a data configuration example of the CM in charge management information. As described above, in the CM in charge management information 113, the volume number of the logical volume and a CM in charge number indicating the CM in charge of the logical volume are registered in association with each other. In addition to the above, the management CM number of the secondary cache is registered in association with the volume number of the logical volume in the CM in charge management information 113. The management CM number indicates the number of the CM that manages the secondary cache used for the I/O processing for the corresponding logical volume. The “CM that manages the secondary cache” refers to the CM that holds the management data for managing the secondary cache in the RAM 102 of its own device,

For example, as illustrated in the volume numbers “0” and “2” in FIG. 14, the CM in charge and the CM that manages the secondary cache are usually the same CM. Therefore, in an initial state, the same value as the CM in charge number is registered as the management CM number. However, in step S63 of FIG. 13, the CM number of the switching source CM is transmitted to the switching destination CM, and the CM in charge management information 113 in the switching destination CM is overwritten and registered with the transmitted CM number as the management CM number. Therefore, as illustrated in the volume number “1” in FIG. 14, the CM in charge number and the management CM number do not match.

Note that FIG. 14 above is an example of a method for holding the management CM number in the CM. The management CM number does not necessarily have to be registered in the CM in charge management information 113, and may be stored in the CM in association with the volume number.

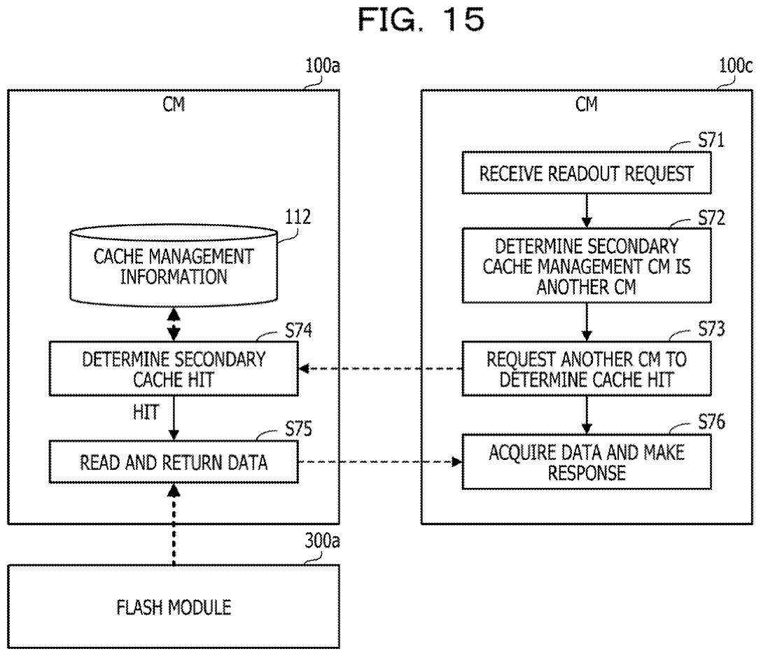

FIG. 15 is an example of a sequence diagram illustrating readout processing in a switching destination CM after completion of the switching processing B.

As described above, when the switching processing As illustrated FIG. 13 is completed, the switching destination CM 100c starts the I/O processing for the logical volume LV1. In the I/O processing at this time, the primary cache secured in the RAM 102 of the CM 100c is used, but the secondary cache secured in the flash module 300b connected to the CM 100c is not used, Instead, the switching source CM 100a is requested to determine whether the secondary cache is hit, and the CM 100a accesses the secondary cache in the case where the secondary cache is hit.

For example, it is assumed that the host server transmits the readout request for the data from the logical volume LV1 and the CM 100c receives the readout request (step S71). Furthermore, it is assumed that the cache control unit 123 of the CM 100c determines that the primary cache is not hit on the basis of the cache management information 112 held by the CM 100c. Then, the cache control unit 123 of the CM 100c then refers to the CM in charge management information 113 in the CM 100c, and acquires the management CM number of the secondary cache corresponding to the readout source logical volume.

Here, it is assumed that the CM indicated by the acquired management CM number is another CM (switching source CM 100a) (step S72). In this case, the cache control unit 123 of the CM 100c requests the switching source CM 100a to determine the secondary cache hit (step S73). At this time, the readout position information in the logical volume LV1 is specified for the CM 100a.

The cache control unit 123 of the CM 100a refers to the cache management information 112 held by the CM 100a and determines whether the secondary cache is hit (step S74). Here, it is assumed that the hash key based on the specified readout position information matches the record number of any record in the secondary cache hash table in the cache management information 112, and is determined as the secondary cache hit. In this case, the cache control unit 123 of the CM 100a reads the data requested to be read from the switching source secondary cache after switching secured in the flash module 300a, and returns the data to the CM 100c (step S75).

The cache control unit 123 of the CM 100c acquires the returned data. This data is transmitted from the host communication unit 121 of the CM 100c to the host server, whereby the response processing is executed (step S76). Actually, the read data is copied to the primary cache of the CM 100c and then transmitted to the host server.

Note that, in the case where a secondary cache miss is determined in step S74, the fact of the secondary cache miss is notified to the switching destination CM 100c. The cache control unit 123 of the CM 100c reads the data requested to be read from the back-end storage area, copies the data to the primary cache in the CM 100c, and then transmits the data to the host server. In the example of FIG. 15, the cache control unit 123 of the CM 100c acquires the data requested to be read from the corresponding HDD in the disk array 200a via the switching source CM 100a.

Alternatively, in the case where the secondary cache miss is determined in step S74, data may be read from the disk array 200a by the cache control unit 123 of the switching source CM 100a. In this case, the read data is transferred to the CM 100c, and the cache control unit 123 of the CM 100a copies the data to the primary cache in the CM 100c and then transmits the data to the host server.

Note that the following processing is executed for the write request. For example, in the case where the primary cache is not hit for the write request, the switching destination CM 100c notifies the switching source CM 100a of the write destination address information. The switching source CM 100a determines whether the secondary cache is hit on the basis of the notified address information. In the case where the secondary cache is hit, the CM 100a excludes the corresponding data on the secondary cache from the write back target and notifies the switching destination CM 100c of permission to write data. Meanwhile, in the case where the secondary cache is not hit, the CM 100a notifies the switching destination CM 100c of permission to write data. The CM 100c that has received the permission notification stores the data requested to be written to the primary cache in the CM 100c, and responds to the write request.

Here, in the switching processing A illustrated in FIG. 11, the larger the data amount of dirty data remaining in the switching source secondary cache, the larger the data amount of management data copied to the switching destination CM. Therefore, the larger the data amount of dirty data, the longer the time during which the I/O processing of the logical volume LV1 stops. In contrast, in the switching processing B illustrated in FIG. 13, the switching processing is completed by transmitting and recording the management CM number of the secondary cache to the switching destination CM. Therefore, the time during which the I/O processing of the logical volume LV1 stops can be shortened as compared with the switching processing A.

Meanwhile, in the I/O processing after switching, in the case where the primary cache is not hit, determination of the secondary cache hit is requested to the switching source CM. As illustrated in FIG. 12, even if the switching processing A is executed, inter-CM communication may occur during the I/O processing after the switching, but in the case of the switching processing B, the inter-CM communication necessarily occurs in the case where the primary cache is not hit. Therefore, the I/O performance of the logical volume LV1 after switching is lower than that when the switching processing A is executed.

As described above, since both the switching processing A and switching processing B have advantages and disadvantages, in the present embodiment, when the switching of the CM in charge is instructed, either the switching processing A or the switching processing B is adaptively selected and executed. Specifically, in the case where the time during which the I/O processing stops is expected to exceed a predetermined determination threshold value when it is assumed that the switching processing A is executed, the switching processing B is executed. As a result, the stop time of the I/O processing due to switching can be suppressed.

Furthermore, when the switching processing B is completed and the I/O processing at the switching destination CM is started, the switching source CM sequentially writes back the dirty data remaining in the secondary cache. Then, as the dirty data in the secondary cache decreases and the data amount of management data to be transferred to the switching destination CM decreases, the expected time during which the I/O processing stops becomes the above-described determination threshold value or less, the switching processing A is executed instead of the switching processing B. This improves the performance of the I/O processing by the switching destination CM.

Here, which method is used to execute the switching processing is determined by, for example, whether a condition of the following equation (1) is satisfied. In the case where the condition of the equation (1) is satisfied, the switching processing B is executed, or in the case where the condition of the equation (1) is not satisfied, the switching processing A is executed.

(The data amount of management data to be transferred to the switching destination CM)/(inter-CM throughput)>permissible stop time of the I/O processing (1)

The permissible stop time on the right side in the equation (1) corresponds to the above-described determination threshold value The data amount of management data in the equation (1) is calculated from the data amount of dirty data remaining in the secondary cache, the number of cache pages in which the data attribute indicates the dirty data among the cache pages of the secondary cache, or the number of pieces of management data corresponding to the cache page Furthermore, the throughput and permissible stop time in the equation (1) are set to predetermined values. Among the values, the permissible stop time may be arbitrarily set as a time permissible as a response time from transmission of the I/O request (for example, the readout request) to reception of a response by the host server, for example. For example, a method of setting the permissible stop time as timeout time or a shorter time than the timeout time of the host server at the time of transmitting the I/O request is conceivable. Furthermore, for example, the permissible stop time may be set as a value within a general maximum response time in a storage device such as an HDD.

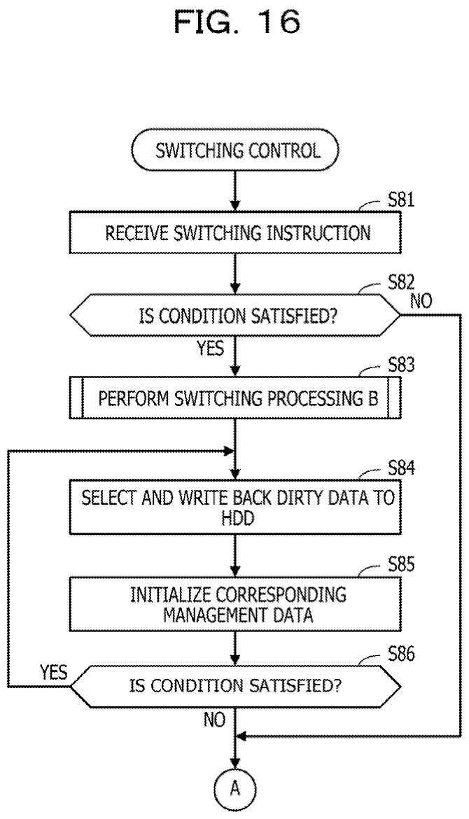

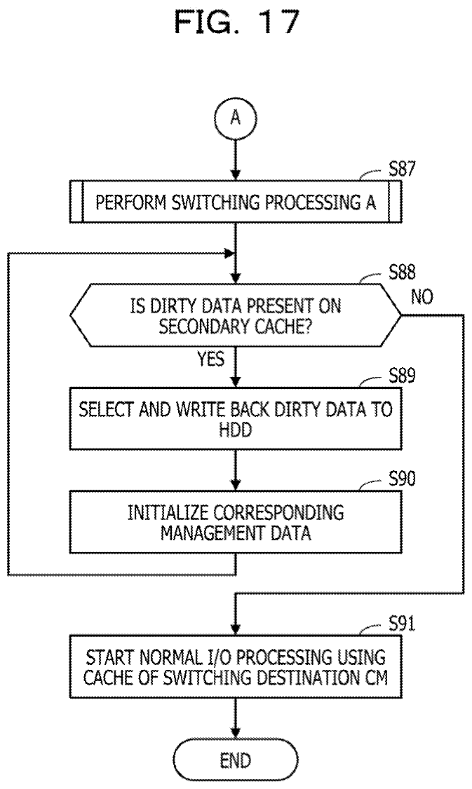

FIGS. 16 and 17 are examples of a flowchart illustrating the switching control processing when switching of the CM in charge is instructed. In FIGS. 16 and 17, as an example, it is assumed that the CM in charge is instructed to be switched from the CM 100a to the CM 100c.

[step S81] When the switching instruction for switching the CM in charge of the logical volume LV1 from the CM 100a to the CM 100c is transmitted from the management terminal 500 to the CM 100a, the host communication unit 121 of the CM 100a receives the switching instruction and passes the switching instruction to the switching control unit 125.

[step S82] The switching control unit 125 refers to the cache management information 112 held by the CM 100a, and counts the number of cache pages having the data attribute indicating dirty data among the cache pages of the secondary cache. The switching control unit 125 converts the data amount of management data in the above equation (1) from the counted value, and determines whether the condition of the equation (1) is satisfied on the basis of the converted value, and the predetermined inter-CM throughput and permissible stop time of the I/O processing. In the case where the condition is satisfied, the processing proceeds to step S83. On the other hand, in the case where the condition is not satisfied, the processing proceeds to step S87 and the switching processing A is executed.

[step S83] The switching processing B illustrated in FIG. 13 is executed under the control of the switching control unit 125. As a result, the number of the CM 100a is transferred to the switching destination CM 100c as the management CM number of the secondary cache, and the I/O processing of the logical volume LV1 is restarted by the CM 100c.

[step S84] The switching control unit 125 selects one cache page that stores the dirty data among the cache pages on the secondary cache on the basis of the cache management information 112 held by the CM 100a. The switching control unit 125 specifies the ID of the selected cache page to the cache control unit 123, and instructs the cache control unit 123 to write back the data in the cache page. In response to this instruction, the cache control unit 123 writes back the corresponding data in the secondary cache to the corresponding HDD of the disk array 200a.

[step S85] The cache control unit 123 initializes the management data corresponding to the cache page written back in step S84 among the management data of the cache management information 112. In this initialization, for example, the data attribute in the page management information may be updated to indicate clean data, or the corresponding page management information and the corresponding record on the hash table may be deleted from the cache management information 112.

[step S86] The switching control unit 125 refers to the cache management information 112 held by the CM 100a again, and counts the number of cache pages having the data attribute indicating dirty data among the cache pages of the secondary cache. The switching control unit 125 converts the data amount of the management data in the equation (1) from the counted value, and determines whether the condition of the equation (1) is satisfied using this value. In the case where the condition is satisfied, the processing proceeds to step S84 and one cache page storing dirty data is selected. In the case where the condition is not satisfied, the processing proceeds to step S87.

[step S87] The switching processing A illustrated in FIG. 11 is executed under the control of the switching control unit 125. As a result, the management data related to the secondary cache among the management data included in the cache management information 112 is copied to the switching destination CM 100c, and the CM 100c restarts the I/O processing for the logical volume LV1.

[step S88] The switching control unit 125 refers to the cache management information 112 held by the CM 100a, and determines whether the dirty data remains in the secondary cache. In the case where the dirty data remains, the processing proceeds to step S89, or in the case where no dirty data remains, the processing proceeds to step S91.

[step S89] The cache page in which the dirty data is stored is selected from the secondary cache by a similar processing procedure to step S84, and this dirty data is written back to the HDD.

[step S90] The management data corresponding to the cache page to which the write back has been performed is initialized by a similar processing procedure to step S85. After that, the processing proceeds to step S88, and the presence or absence of dirty data in the secondary cache is determined.

[step S91] The switching control unit 125 notifies the switching destination CM 100c that the write back from the secondary cache has been completed. When receiving the notification, the CM 100c starts normal I/O control using the secondary cache (secondary cache after switching) secured in the disk array 200b connected to the CM 100c in addition to the primary cache in the CM 100c. As a result, for the secondary cache, the I/O processing is controlled using only the secondary cache after switching without using the switching source secondary cache. Furthermore, in the case where the secondary cache after switching is not used in step S87, use of the secondary cache after switching is started in step S91.

Note that, in the case where the cache management information 112 for the logical volume LV1 remains in the RAM 102 of the CM 100a, the switching control unit 125 of the switching source CM 100a deletes the cache management information 112.

In the above-described second embodiment, the response time from the switching instruction to the switching completion of the CM in charge can be shortened as compared with the comparative example illustrated in FIG. 10. Furthermore, since the switching processing A or B is selected and executed according to the status of the switching source secondary cache, the stop time of the I/O processing of the logical volume at the time of switching can be suppressed, and as a result, the time spent to make a switching completion response can be suppressed, At the same time, the deterioration of the response performance of the I/O processing in the switching destination CM can be suppressed while suppressing the stop time of the I/O processing.

Moreover, after the switching processing B is executed, the switching processing A is executed at the stage where the expected stop time of the I/O processing in the switching processing A becomes a permissible value or less with the progress of write back in the switching source secondary cache. As a result, the response performance of the I/O processing in the switching destination CM can be improved.

Note that the processing functions of the devices (for example, the storage control devices 10 and 20, the CMs 100a to 100d, the host servers 400a and 400b, the management terminal 500) illustrated in each of the above embodiments can be implemented by a computer. In that case, a program describing the processing content of the functions to be held by each device is provided, and the above processing functions are implemented on the computer by execution of the program on the computer. The program describing the processing content can be recorded on a computer-readable recording medium. The computer-readable recording medium includes a magnetic storage device, an optical disk, a semiconductor memory, or the like, The magnetic storage device includes a hard disk drive (HDD), a magnetic tape, or the like. The optical disk includes a compact disk (CD), a digital versatile disk (DVD), a Blu-ray disk (BD, registered trademark), or the like.

In a case where the program is to be distributed, for example, portable recording media such as DVDs and CDs, in which the program is recorded, are sold. Furthermore, it is also possible to store the program in a storage device of a server computer and transfer the program from the server computer to another computer via a network.

The computer that executes the program stores, for example, the program recorded on the portable recording medium or the program transferred from the server computer in its own storage device. Then, the computer reads the program from its own storage device of the computer and executes processing according to the program. Note that, the computer can also read the program directly from the portable recording medium and execute processing according to the program. Furthermore, the computer can also sequentially execute processing according to the received program each time when the program is transferred from the server computer connected via the network.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A storage system comprising:
a first storage control device; and
a second storage control device, wherein,
in a state of controlling input/output (I/O) processing for a logical storage area using a cache, when receiving a switching instruction configured to switch a device in charge that controls the I/O processing for the logical storage area from the first storage control device to the second storage control device, the first storage control device performs first switching processing of notifying the second storage control device of a management device number that indicates the first storage control device as a device that manages the cache, and executing response processing for the switching instruction to switch the device in charge, and
when receiving a determination request as to whether data requested to be read from the logical storage area by a readout request hits the cache from the second storage control device after execution of the first switching processing, the first storage control device determines whether the data hits the cache, and
when receiving the readout request after execution of the first switching processing, the second storage control device transmits the determination request to the first storage control device indicated by the notified management device number.

2. The storage system according to claim 1, wherein,
in the first switching processing, the first storage control device stops the I/O processing for the logical storage area, and notifies the second storage control device of the management device number, executes the response processing, and causes the second storage control device to start the I/O processing for the logical storage area, and
moreover, when receiving the switching instruction,
the first storage control device stops the I/O processing for the logical storage area, copies management information configured to manage dirty data stored in the cache from a storage device in the first storage control device and transmits the copied management information to the second storage control device, and executes the response processing, and in a case of assuming that second switching processing of causing the second storage control device to start the I/O processing for the logical storage area is executed, the first storage control device calculates a stop time during which the I/O processing for the logical storage area stops on a basis of a data amount of the management information, and
the first storage control device executes the first switching processing in a case where the stop time exceeds a predetermined threshold value, or executes the second switching processing in a case where the stop time is equal to or less than the threshold value.

3. The storage system according to claim 2, wherein,
when receiving the readout request after execution of the second switching processing, the second storage control device determines whether the data hits the cache on a basis of the management information transmitted from the first storage control device.

4. The storage system according to claim 2, wherein,
after execution of the first switching processing, the first storage control device further sequentially writes back dirty data stored in the cache to a physical storage area that implements the logical storage area, and sequentially deletes information regarding the dirty data for which the write back has been completed from the management information, and
calculates the stop time on a basis of a current data amount of the management information during execution of the write back, and executes the second switching processing in a case where the calculated stop time becomes equal to or less than the threshold value.

5. The storage system according to claim 2, wherein
the first storage control device further sequentially writes back dirty data stored in the cache to a physical storage area that implements the logical storage area after execution of the second switching processing, and
starts use of a new cache secured in a storage area connected to the second storage control device in the I/O processing for the logical storage area by the second storage control device when the write back of all the dirty data in the cache has been completed.

6. A storage control device comprising:
a memory; and
a processor coupled to the memory and configured to:
in a state of controlling input/output (I/O) processing for a logical storage area using a cache, when receiving a switching instruction configured to switch a device in charge that controls the I/O processing for the logical storage area from the storage control device to another storage control device, perform first switching processing of notifying the another storage control device of a management device number that indicates the storage control device as a device that manages the cache, and executing response processing for the switching instruction to switch the device in charge; and
when receiving a determination request as to whether data requested to be read from the logical storage area by a readout request hits the cache from the another storage control device after execution of the first switching processing, determine whether the data hits the cache.

7. The storage control device according to claim 6, wherein,
in the first switching processing, the processor stops the I/O processing for the logical storage area, and notifies the another storage control device of the management device number, executes the response processing, and causes the second storage control device to start the I/O processing for the logical storage area, and
when receiving the switching instruction, the processor stops the I/O processing for the logical storage area, copies management information configured to manage dirty data stored in the cache from a storage device in the storage control device and transmits the copied management information to the another storage control device, and executes the response processing, and in a case of assuming that second switching processing of causing the another storage control device to start the I/O processing for the logical storage area is executed, the first storage control device calculates a stop time during which the I/O processing for the logical storage area stops on a basis of a data amount of the management information, and
the processor executes the first switching processing in a case where the stop time exceeds a predetermined threshold value, or executes the second switching processing in a case where the stop time is equal to or less than the threshold value.

8. The storage control device according to claim 7, wherein,
after execution of the first switching processing, the processor further sequentially writes back dirty data stored in the cache to a physical storage area that implements the logical storage area, and sequentially deletes information regarding the dirty data for which the write back has been completed from the management information, and
calculates the stop time on a basis of a current data amount of the management information during execution of the write back, and executes the second switching processing in a case where the calculated stop time becomes equal to or less than the threshold value.

9. The storage control device according to claim 7, wherein
the processor further sequentially writes back dirty data stored in the cache to a physical storage area that implements the logical storage area after execution of the second switching processing, and
starts use of a new cache secured in a storage area connected to the second storage control device in the I/O processing for the logical storage area by the another storage control device when the write back of all the dirty data in the cache has been completed.

10. A storage control method comprising:
in a state of controlling input/output (I/O) processing for a logical storage area using a cache, when receiving a switching instruction configured to switch a device in charge that controls the I/O processing for the logical storage area from the storage control device to another storage control device, performing, by a storage control device, first switching processing of notifying the another storage control device of a management device number that indicates the storage control device as a device that manages the cache, and executing response processing for the switching instruction to switch the device in charge; and
when receiving a determination request as to whether data requested to be read from the logical storage area by a readout request hits the cache from the another storage control device after execution of the first switching processing, determining whether the data hits the cache.
